(19) United States
(12) Patent Application Publication
(10) Pub. No.: US 2009/0087102 A1
(43) Pub. Date: Apr. 2, 2009

(54) METHOD AND APPARATUS FOR REGISTERING IMAGE IN TELEPHONE DIRECTORY OF PORTABLE TERMINAL

(75) Inventor: Seung Yeob Lee, Seongnam-si (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/145,108

(22) Filed: Jun. 24, 2008

(30) Foreign Application Priority Data
Sep. 27, 2007 (KR) 2007-0097222

(51) Int. Cl. G06K 9/66

(52) U.S. Cl. 382/195

(57) ABSTRACT

A method and an apparatus for registering an image in a telephone directory of a portable terminal are provided. The method includes identifying at least one face area in an image displayed on a screen, selecting a face area to be registered in the telephone directory from the at least one identified face area, generating a face area capture image from the selected image, and registering the face area capture image in the telephone directory. A user may thereby easily retrieve a telephone number of the registered person.

### PRIORITY

This application claims the benefit under 35 U.S.C. §119(a) of a Korean patent application filed in the Korean Intellectual Property Office on Sep. 27, 2007 and assigned Serial No. 2007-0097222, the entire disclosure of which is hereby incorporated by reference.

### BACKGROUND OF THE INVENTION

1. Field of the Invention

The present invention relates to a portable terminal. More particularly, the present invention relates to a method and an apparatus for registering an image in a telephone directory of a portable terminal with a corresponding telephone number registered in the telephone directory.

2. Description of the Related Art

When a user registers a telephone number in a telephone directory of a portable terminal, a name, an E-mail address, a birthday, an address, an anniversary and an image as well as the telephone number of a person can be registered. The portable terminal not only performs a voice communication function but also is used for managing a variety of private information. In particular, if the user registers an image of a person with a telephone number of the person, it is easy to correctly remember the person's face and match the face with the telephone number of the person. However, in a conventional portable terminal, if a person's face in a registered image in a telephone directory of the portable terminal is small or if the registered image includes several people, it may be difficult to identify the person.

### SUMMARY OF THE INVENTION

An aspect of the present invention is to address at least the above-mentioned problems and/or disadvantages and to provide at least the advantages described below. Accordingly, an aspect of the present invention is to provide a method for registering an image having an enlarged facial area of a registered person in a telephone directory of a portable terminal, thereby enabling easy retrieval of a telephone number of the person.

In accordance with an aspect of the present invention, a method for registering an image in a telephone directory of a portable terminal is provided. The method includes generating a face area capture image from a displayed image on a screen, and registering the face area capture image in the telephone directory.

In accordance with another aspect of the present invention, an apparatus for registering an image in a telephone directory of a portable terminal is provided. The apparatus include an image generating module for generating a face area capture image from a displayed image on a screen, and an image registering module for registering the face area capture image in the telephone directory.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 illustrates a configuration of a portable terminal according to an exemplary embodiment of the present invention;

FIG. 2 illustrates a process of enlarging a face area capture image according to an exemplary embodiment of the present invention;

FIG. 3 is a flowchart illustrating a method for registering an image in a telephone directory of a portable terminal according to an exemplary embodiment of the present invention; and

FIG. 4 is a flowchart illustrating an executing process of a face image registering mode according to an exemplary embodiment of the present invention.

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions will be omitted for clarity and conciseness.

In exemplary embodiments described hereinafter, a portable terminal having a face image register function of the present invention is exemplified as a mobile communication terminal by way of example. The present invention is not limited thereto. That is, the portable terminal according to exemplary embodiments of the present invention may be any information communication instrument and multimedia instrument having a telephone directory function capable of registering images, such as a mobile communication terminal, a digital broadcasting terminal, a Portable Multimedia Player (PMP), a digital camera, a navigation terminal, a Personal Digital Assistant (PDA), a smart phone, an International Mobile Telecommunication 2000 (IMT-2000) terminal, a Wideband Code Division Multiple Access (WCDMA) terminal, a Universal Mobile Telecommunication Service (UMTS) terminal, and their applications, so as to provide convenience to a user.

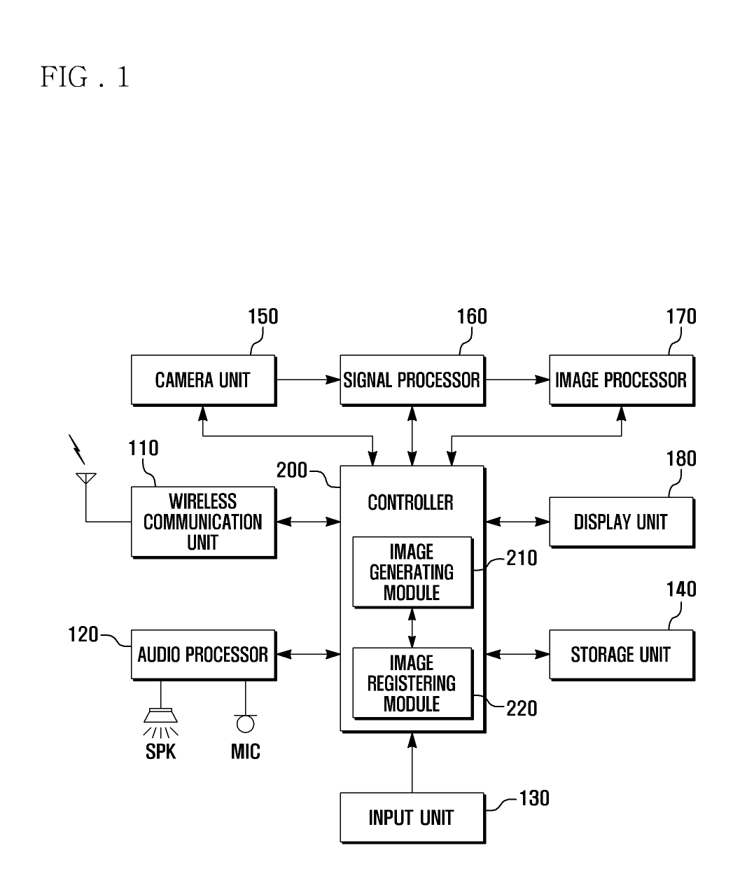

FIG. 1 illustrates a configuration of a portable terminal according to an exemplary embodiment of the present invention.

Referring to FIG. 1, the portable terminal includes a wireless communication unit 110, an audio processor 120, an input unit 130, a storage unit 140, a camera unit 150, a signal processor 160, an image processor 170, a display unit 180 and a controller 200.

The wireless communication unit 110 performs communication operations for transmitting and receiving user data, for example message and voice signals, to and from other portable terminals through wireless communication. The wireless communication unit 110 includes a Radio Frequency (RF) transmitter (not shown) that up-converts and amplifies a frequency of a signal to be transmitted, and an RF receiver (not shown) that low-noise amplifies a received signal and down-converts a frequency thereof. The wireless communication unit 110 converts a modulated signal received from the controller 200 into an intermediate frequency and then converts the signal into an RF signal, and transmits the RF signal to a base station via an antenna. Further, the wireless communication unit 110 receives an RF signal from the base station via the antenna and sequentially converts it into an intermediate frequency and then into a baseband frequency, and provides the baseband signal to the controller 200.

The audio processor 120 reproduces an audio signal received from the controller 200 and transmits an audio signal such as a voice input through a microphone (MIC) to the controller 200. That is, the audio processor 120 converts an analog voice signal received from the microphone (MIC) into a digital signal and transmits the digital signal to the controller 200, and converts a digital signal of a voice received from the controller 200 into an audible analog signal and outputs the analog signal to a speaker (SPK).

The input unit 130 includes various input keys and function keys for inputting numeric and text information and for setting a variety of functions. The function keys may include a directional key, a side key and a shortcut key that are set to perform preset functions. Also, the input unit 130 transmits a key signal input with reference to a user setting and a function control of the portable terminal to the controller 200.

In an exemplary configuration, the input unit 130 may include a shortcut key for a camera function. That is, the portable terminal may be provided with a key corresponding to a shutter of a general camera at a side surface of the portable terminal for easy photographing.

The storage unit 140 stores application programs needed to operate functions according to an exemplary embodiment of the present invention, and contents to be downloaded and user data generated by a user. Further, the storage unit 140 may include at least one buffer for temporarily storing user data (for example, photographed images) generated during an application program operation according to the camera function.

The storage unit 140 includes a program area and a data area. The program area stores an Operating System (OS) for initializing the portable terminal and application programs for a text message and other applications. When a function is to be activated according to a user's request, the storage unit 140 provides the function through the application programs under the control of the controller 200. The program area stores overall programs for the controller 200 to detect a subject in a camera mode and generate a photographing signal. The data area stores user data generated according to the use of the portable terminal and may also store images photographed through the camera unit 150.

The camera unit 150 may include an image sensor (not shown), an encoder (not shown) and a thumbnail buffer (not shown).

The image sensor photographs the subject and generates image data. The generated image data may have a Bayer format. A Charge Coupled Device (CCD) or a Complementary Metal Oxide Semiconductor (CMOS) image sensor may be used as the image sensor.

The thumbnail buffer temporarily stores thumbnail image data until main image data that is transferred from the camera is completely compressed.

After compression of the main image data transferred from the camera is completed, the encoder receives and compresses the temporarily stored thumbnail image data from the thumbnail buffer. The encoder compresses the main and thumbnail image data in a Joint Photographic Experts Group (JPEG) format.

In particular, an image generating module 210 of the controller 200 automatically enlarges a face area of the photographed subject, or manually enlarges a face area of the photographed subject according to a user's input, thereby performing a function for generating a face area capture image of the subject.

The signal processor 160 includes a signal processing device that converts an electrical signal output from the camera unit 150 into a digital signal. The signal processing device may be embodied as a Digital Signal Processor (DSP), but is not limited thereto.

The image processor 170 generates image data to display the digital signal output from the signal processor 160. More specifically, the image processor 170 processes the digital signal into a frame unit, then edits the digital signal to be suitable for the display characteristics and size of the display unit 180. The image processor 170 then outputs the image data to the display unit 180 through the controller 200. The image processor 170 has an image COder/DECoder (CODEC) to compress the image data that is to be displayed on the display unit 180 and to restore the compressed image data into the original image data. A JPEG CODEC, an MPEG CODEC and a wavelet CODEC and the like may be used as the image CODEC.

The display unit 180 provides a variety of information, such as a menu in the portable terminal, user data input by a user and function setting information for the user, on a display screen. The display unit 180 may be provided as a Liquid Crystal Display (LCD). In this case, the display unit 180 may include a controller for controlling the LCD, a video memory in which image data is stored and an LCD element. If the LCD is provided as a touch screen, the display unit 180 performs a part or all of the functions of the input unit 130.

More particularly, the display unit 180 provides an image of a subject to be photographed by a camera provided in the portable terminal in a preview screen. A preview screen function shows an image of the subject entering through a lens before the image is actually photographed by the camera. Further, the display unit 180 may display the image photographed by the camera before storing and display a confirmation request message for storing and deleting by the user.

The controller 200 controls overall operations in the portable terminal and signal flows between internal units in the portable terminal. That is, the controller 200 controls the signal flows between the wireless communication unit 110, the audio processor 120, the input unit 130, the storage unit 140, the camera unit 150, the signal processor 160, the image processor 170 and the display unit 180.

Also, the controller 200 executes functions of the portable terminal according to an input signal from the input unit 130 and displays information on a current state according to the function execution, user menu, etc. through the display unit 180.

The controller 200 includes an image generating module 210 that detects a face area of the subject photographed by the camera unit 150, and an image registering module 220 that adjusts the detected face area to be arranged on the whole screen with a maximum magnification ratio.

In an exemplary embodiment of the present embodiment, the image generating module 210 and the image registering module 220 are separately provided. However, the image generating module 210 and the image registering module 220 may also be integrated into a face detecting control module (not shown) in the controller 200.

The image generating module 210 identifies and selects the face area of the subject from a captured image on the screen in a preview mode or from an image stored in the portable terminal to generate a face area capture image, and transmits the face area capture image to the image registering module 220. The face area capture image refers to the face of the subject or a preset area including the face of the subject.

The image generating module 210 may determine the subject through continuous images of the subject captured on the screen in the preview mode. Then, the image generating module 210 then detects characteristics of the face including eyes, nose and mouth from the image of the subject, and identifies the face according to the detected characteristics and captures the image of the face area. Thereafter, the image generating module 210 transmits the face area capture image to the image registering module 220. Here, if two or more people are photographed by the camera unit 150, the image generating module 210 may capture all of the face area capture images and enable the user to select a face area to be registered in a telephone directory. Thereafter, the image generating module 210 generates a captured image of the selected face area and transmits the image to the image registering module 220.

Faces of people may appear differently according to, for example, changes in shape, such as the front and side appearance according to viewing direction, inclinations of one's head and various expressions, sizes of face images according to a distance from a camera, and changes in external factors such as brightness differences in a face according to light conditions, complex backgrounds, another subject having a color similar to a face color and the like. A knowledge-based method, a feature-based method, a template-matching method and an appearance-based method may be used for detecting the face area in a face recognition field.

The knowledge-based method is based on the knowledge of researchers that a human face includes various face elements such as eyebrows, eyes, nose, mouth, etc. and that the respective face elements have certain distances and positional relationships therebetween. According to this method in the case of an image having a front face image, a face area can be detected using regulations of sizes and positions of the face elements. However, a face area is difficult to be detected from images having a variety of changes such as inclinations of a head, viewing angles of a front face, and expressions, and therefore the knowledge-based method can only be applied to some limited cases. This problem may be solved by expanding various regulations or by regulating all possible conditions.

In the feature-based method, a face area can be detected using information on sizes, shapes and relationships of face characteristics, color and texture of a face and mixtures of these elements. According to this method, it is possible to easily detect the face area in a short time. However, misrecognition may occur backgrounds or subjects having a color similar to a face color, loss in face color and texture information may occur according to light conditions, and non-detection for some face characteristics may occur according to inclination degrees of the head. Therefore, the feature-based method is relatively sensitive to pose, light conditions, complex backgrounds, etc.

In the template-matching method, a standardized template pre-made for every face that may be a subject is compared with an input image to detect a face area. According to the template-matching method, it is unnecessary to detect individual face characteristics, and therefore influences of light conditions, backgrounds, etc. are reduced and thus face detection is possible in conditions such as complex backgrounds. However, the template-matching method is sensitive to changes in size of faces according to a distance, rotation angles of a face, inclinations of a head, etc., and also an average template including all personal information is difficult to be generated. Thereby it requires a substantial effort to make the template. This problem can be addressed by making the template with various sizes and shapes.

In the appearance-based method, a face area can be detected using a model learned by a learning image group. The appearance-based method may use linear discriminant analysis, a neural network, a support vector machine, or an Eigenface generated by principal component analysis. According to this method, Eigenvectors, learned using a learning data group of the face area and of a non-face area, are created so as to detect the face area from complex images, enabling the face area to be detected using the Eigenvectors. This appearance-based method can overcome the above-described limitations in the other detection methods, and has high identification reliability. However, it requires much time to learn a database. Further, it is necessary to learn an updated database if changes are made in the database.

The above-described face detection methods may be selected by a designer during the design of the portable terminal and applied to the image generating module 210. Further, it is possible to automatically or manually determine whether an image of a subject photographed by the camera unit 150 is a human image. For example, if an auto zoom control function is provided in the camera unit 150, the image generating module 210 can automatically zoom-in on the face area of the subject using the auto zoom control function of the camera unit 150 and display it on the screen. Alternatively, if there is no auto zoom control function, the image generating module 210 can zoom-in on the face area of the subject according to an input signal of a user.

The image registering module 220 controls the size of the face area capture image transmitted from the image generating module 210 to be suitable for the overall screen size. Typically, the portable terminal can display the image on the screen with various sizes, such as 128*96 pixels, 160*120 pixels, 320*240 pixels or 640*480 pixels. Further, a thumbnail image that is used for viewing an image album or retrieving the image generally uses a size of 176*220 pixels. The size of the image registered in a telephone directory may be set as one of the above sizes.

For example, if the user inputs a signal to register the image with a size of 160*120 pixels, the image registering module 220 detects the signal and enlarges the face area capture image received from the image generating module 210 to be arranged on a screen area of 160*120 pixels, and registers the enlarged image in the telephone directory.

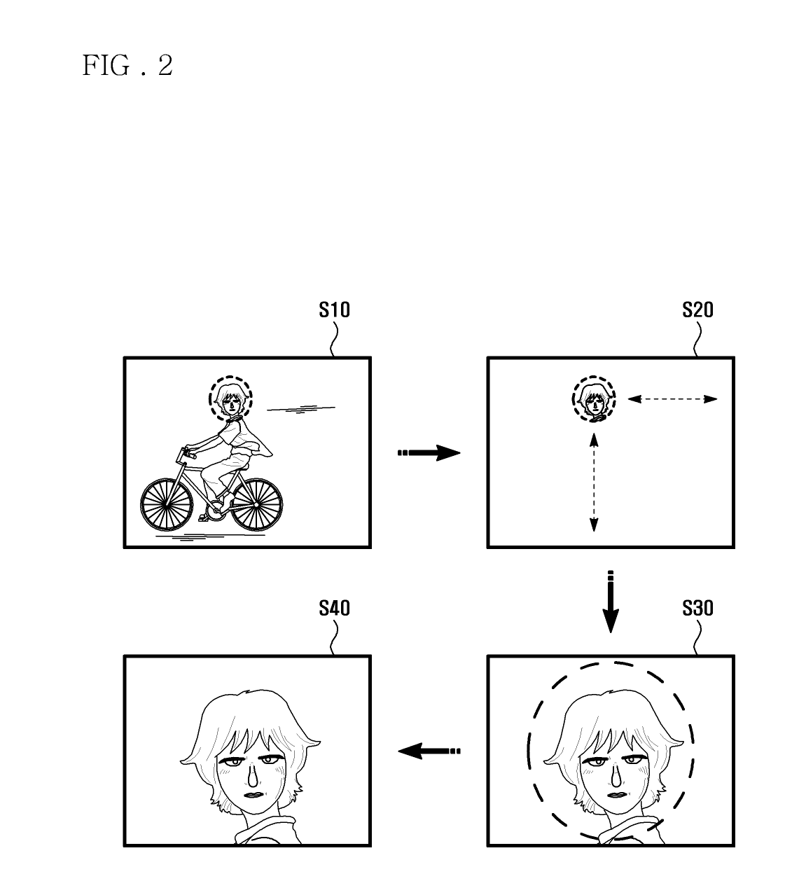

FIG. 2 illustrates a process of enlarging a face area capture image according to an exemplary embodiment of the present invention.

Referring to FIG. 2, the image generating module 210 captures a face area image of a subject and transmits the face area capture image to the image registering module 220 in step S10. The image registering module 220 analyses the face area capture image and calculates a maximum enlargement ratio for the face area capture image through an image control algorithm in step S20. According to the calculation result, the image registering module 220 controls the face area capture image in upward, downward, leftward and rightward directions in step S30, and enlarges the face area capture image to a maximum size and displays the enlarged image on the screen in step S40.

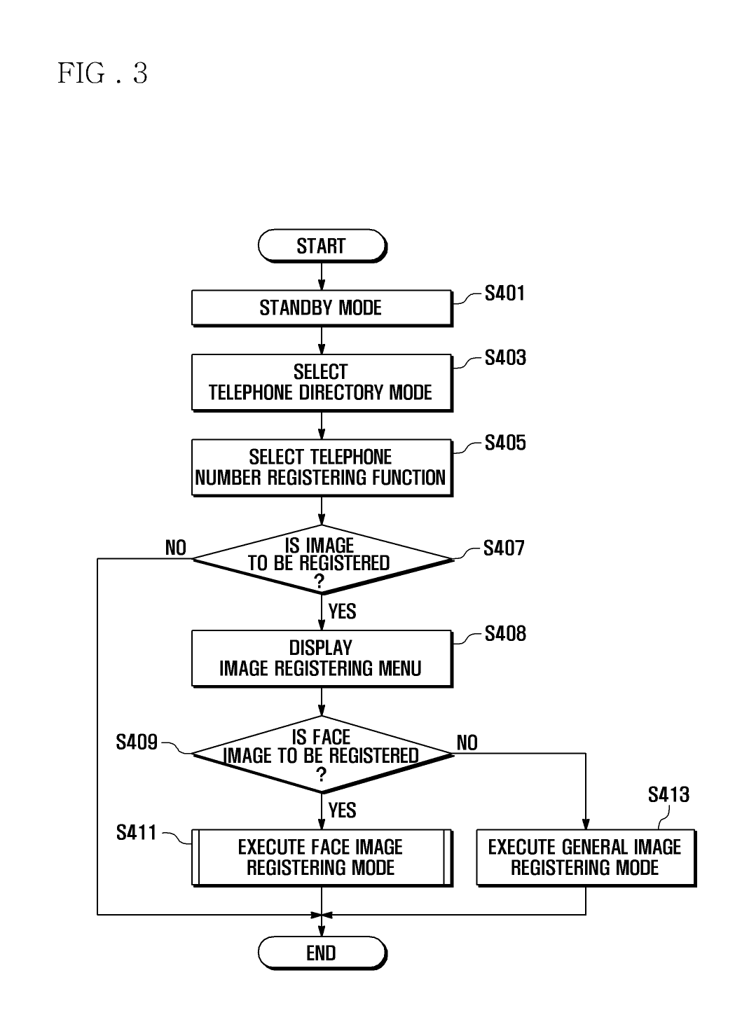

FIG. 3 is a flowchart illustrating a method for registering an image in a telephone directory of the portable terminal according to an exemplary embodiment of the present invention.

Referring to FIG. 3, the controller 200 is in a standby mode in step S401. In the standby mode, a user input a key for selecting a telephone directory mode, and the controller 200 detects the key input and displays the telephone directory mode in step S403. The user then inputs a key for selecting a telephone number registering function in the telephone directory mode in step S405, and the controller 200 registers a telephone number of a person selected by the user. At this time, the user can selectively add personal information, such as a name, an e-mail address and a birthday of the person as well as the telephone number.

The controller 200 determines whether an image registering signal to register an image of the person in the telephone directory is input by the user in step S407. If the controller 200 determines that an image registering signal is input, the controller 200 displays an image registering menu on the screen in step S408. If no image registering signal is input, the image registering process ends. The image registering menu may include a face image registering item and a general image registering item. The face image registering item is a method for detecting and enlarging a face area for registration in the telephone directory, and the general image registering item is a method for registering an image stored in the portable terminal in the telephone directory without any further processing.

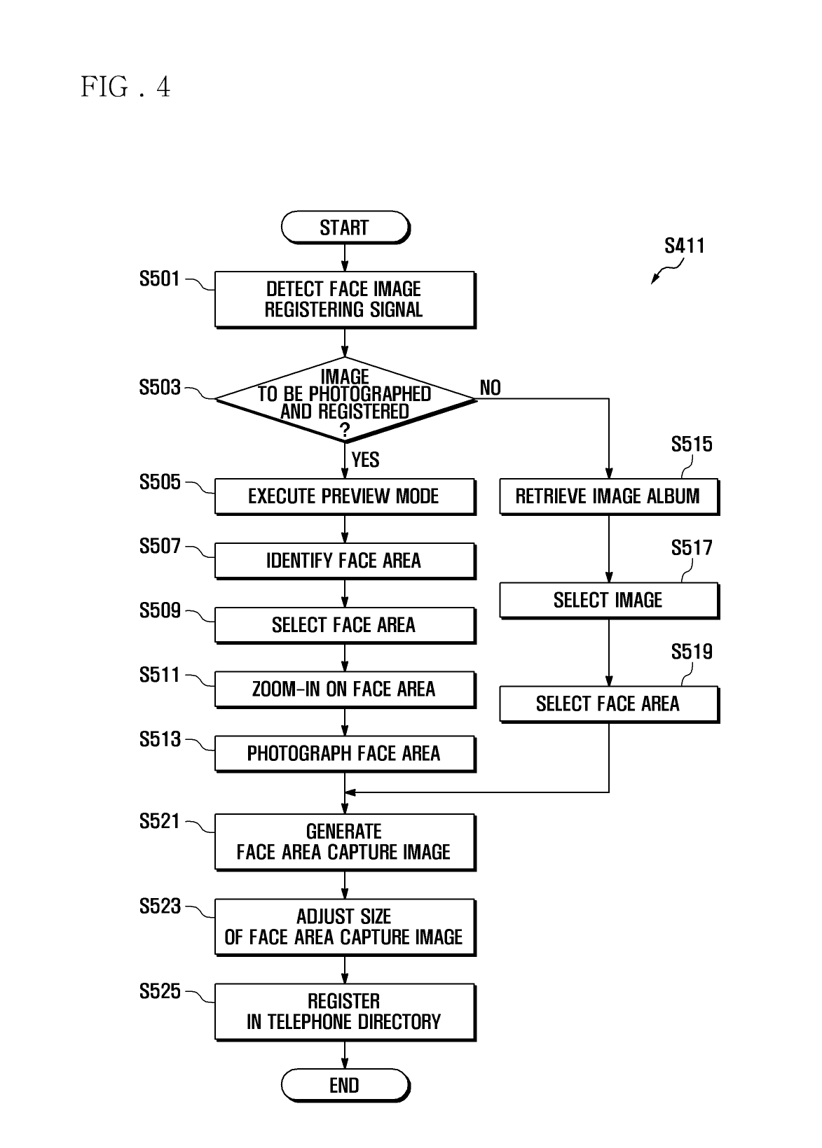

Next, the controller 200 determines whether the user selects the face image registering item in step S409. If the user selects the face image registering item, the controller 200 executes a face image registering mode to detect the face area from an image stored in the image album or captured on the screen in the preview mode in step S411. Thereafter, the controller 200 generates the face area capture image, adjusts the size of the face area capture image, and registers the adjusted image in the telephone directory. The process for executing the face image registering mode is described in detail later with reference to FIG. 4.

If the user does not select the face image registering item at step S409, the controller 200 executes a general image registering mode and registers a general image in the telephone directory in step S413. The general image may be registered by a method known in the art.

FIG. 4 is a flowchart illustrating an executing process of a face image registering mode according to an exemplary embodiment of the present invention.

Referring to FIG. 4, the image generating module 210 detects the face image registering signal input by the user in step S501, and determines whether an image is to be photographed and registered according to an input signal of the user in step S503. If an image photographing signal is input, the controller 200 executes a preview mode, and continues to capture images of the subject and displays the images on the screen in step S505.

The image generating module 210 identifies a face area of the subject from the continuously captured images in step S507. When the user inputs a photographing signal, the image generating module 210 selects the face area to be registered in the telephone directory according to user input through a key pad or a touch pad in step S509. Thereafter, the image generating module 210 automatically or manually zooms-in on the selected face area in step S511, photographs the face area in step S513, and generates a face area capture image in step S521.

If no image photographing signal is input in step S503, the user searches an image album retrieved by the image generating module 210 in step S515 and the user selects the image in which a face area is to be detected in step S517. Thereafter, the image generating module 210 detects a face area to be registered in the telephone directory from the image. In a case that a plurality of face areas exists in the image, the user can select a desired face area therefrom in step S519. The image generating module 210 then generates a capture image of the selected face area in step S521. The face area capture image is generated by the image generating module 210 through a process for separating a preset face area from the image of the subject photographed in step S513 or from the image stored in the portable terminal and selected in step S519.

The image generating module 210 transmits the generated face area capture image to the image registering module 220. The image registering module 220 adjusts the face area capture image into a maximum size to be arranged on the screen in step S523, then registers the arranged face area capture image in the telephone directory in step S525.

Although exemplary embodiments of the present invention have been described in detail hereinabove, it should be understood that many variations and modifications of the basic inventive concept herein described, which may appear to those skilled in the art, will still fall within the spirit and scope of the exemplary embodiments of the present invention as defined in the appended claims and their equivalents.

What is claimed is:

1. A method for registering an image in a telephone directory of a portable terminal, the method comprising:
generating a face area capture image from an image displayed on a screen; and
registering the face area capture image in the telephone directory.

2. The method according to claim 1, wherein the generating of the face area capture image comprises:
identifying at least one face area in the image displayed on the screen; and
selecting a face area to be registered in the telephone directory from the at least one identified face area.

3. The method according to claim 2, wherein the identifying of the at least one face area comprises identifying at least one of a face area and a region comprising the face area in the image displayed on the screen as the face area.

4. The method according to claim 3, wherein the image displayed on the screen comprises at least one of a capture image of a subject displayed on the screen in a preview mode and an image stored in the portable terminal.

5. The method according to claim 4, wherein the identifying of the at least one face area comprises:
identifying at least one face area in the capture image of the subject displayed in the preview mode;
selecting one face area from the identified at least one face area;
zooming-in on the selected face area; and
photographing the zoomed-in face area.

6. The method according to claim 5, wherein the zooming-in on the selected face area comprises:
enlarging the selected face area by at least one of automatic and manual means; and
displaying the enlarged face area on the screen.

7. The method according to claim 4, wherein the identifying of the at least one face area comprises:
displaying the stored image;
selecting the displayed image; and
selecting a face area from the selected image.

8. The method according to claim 2, wherein the generating of the face area capture image further comprises separating the selected face area to generate the face area capture image.

9. The method according to claim 1, further comprising controlling, before registering the face area capture image in the telephone directory, the size of the face area capture image.

10. The method according to claim 9, wherein the controlling of the size of the face area capture image comprises enlarging the face area capture image to be arranged on the overall area of the screen.

11. An apparatus for registering an image in a telephone directory of a portable terminal, the apparatus comprising:
an image generating module for generating a face area capture image from an image displayed on a screen; and
an image registering module for registering the face area capture image in the telephone directory.

12. The apparatus according to claim 11, wherein the image generating module identifies at least one face area in the image displayed on the screen and selects a face area to be registered in the telephone directory from the at least one identified face area.

13. The apparatus according to claim 12, wherein the image generating module identifies at least one of a face area and a region comprising the face area in the image displayed on the screen as the face area.

14. The apparatus according to claim 13, wherein the image displayed on the screen is at least one of a capture image of a subject displayed on the screen in a preview mode and an image stored in the portable terminal.

15. The apparatus according to claim 14, wherein the image generating module identifies at least one face area in the capture image displayed in the preview mode, selects one face area from the identified at least one face area, zooms-in on the selected face area, photographs the zoomed-in face area, and generates the capture image of the face area.

16. The apparatus according to claim 15, wherein the image generating module zooms-in on the selected face area by enlarging the selected face area by at least one of automatic and manual means and displaying the enlarged face area on the screen.

17. The apparatus according to claim 14, wherein the image generating module displays the stored image, selects the displayed image, selects a face area from the selected image, and generates the capture image of the face area.

18. The apparatus according to claim 12, wherein the image generating module separates the selected face area and generates a face area capture image.

19. The apparatus according to claim 11, wherein the image registering module controls the size of the face area capture image.

20. The apparatus according to claim 19, wherein the image registering module enlarges the face area capture image to be arranged on the overall area of the screen.

21. A portable terminal for registering an image in a telephone directory, the portable terminal comprising:
a camera unit for photographing a subject and for generating image data;
a display unit for displaying the generated image date; and
a controller for generating a face area capture image from the image data displayed on the display unit, and for registering the face area capture image in the telephone directory.

22. The portable terminal according to claim 21, wherein the controller comprises:
an image generating module for generating a face area capture image from the image data displayed on the display unit; and
an image registering module for registering the face area capture image in the telephone directory.
